(19) United States
(12) Patent Application Publication
(10) Pub. No.: US 2020/0166002 A1
(43) Pub. Date: May 28, 2020

(54) GDI ENGINE

(71) Applicants: HYUNDAI MOTOR COMPANY, Seoul (KR); KIA MOTORS CORPORATION, Seoul (KR)

(72) Inventors: Hak Ki KIM, Bucheon-si (KR); Eui Seok KIM, Seongnam-si (KR); Kyung Wook CHOI, Ansan-si (KR); Bang Uk LEE, Hwaseong-si (KR); Ki Tae KIM, Suwon-si (KR)

(73) Assignees: HYUNDAI MOTOR COMPANY, Seoul (KR); KIA MOTORS CORPORATION, Seoul (KR)

(21) Appl. No.: 16/415,615

(22) Filed: May 17, 2019

(30) Foreign Application Priority Data
Nov. 22, 2018 (KR) 10-2018-0145347

(51) Int. Cl. F02F 1/24; F02M 61/14; F02F 1/42; F02F 3/26; F02B 23/10

(52) U.S. Cl. CPC F02F 1/242; F02M 61/14; F02F 1/4285; F02B 2023/106; F02B 23/10; F02B 23/104; F02F 3/26

(57) ABSTRACT

A gasoline direct injection (GDI) engine may include: a cylinder block having a cylinder; a cylinder head having an intake port, an intake valve opening and closing the intake port, an exhaust port, and an exhaust valve opening and closing the exhaust port; a piston reciprocating in the cylinder; a combustion chamber defined by the cylinder head, the piston, and an inner wall surface of the cylinder; and a fuel injector injecting a fuel into the combustion chamber. In particular, the combustion chamber is divided into an intake side where the intake port and the intake valve are located, and an exhaust side where the exhaust port and the exhaust valve are located, and a nozzle of the fuel injector is mounted in the cylinder head toward the exhaust side.

### CROSS-REFERENCE TO RELATED APPLICATION

This application claims priority to and the benefit of Korean Patent Application No. 10-2018-0145347, filed on Nov. 22, 2018, the entire contents of which are incorporated herein in by reference.

### FIELD

The present disclosure relates to a gasoline direct injection (GDI) engine capable of reducing particulate matter (PM) and particulate number (PN) and improving combustion performance.

### BACKGROUND

The statements in this section merely provide background information related to the present disclosure and may not constitute prior art.

A gasoline direct injection (GDI) engine is an engine which is designed to directly inject fuel into a combustion chamber. The vaporizing fuel directly injected into the combustion chamber has a cooling effect, increasing volumetric efficiency and allowing a higher compression ratio, and thus the GDI engine has improved fuel efficiency and provides high power output compared to a port fuel injection (PFI) engine.

The GDI engine is able to control injection timing and ignition timing (e.g., retarding the ignition timing), thereby reducing catalyst light-off time (LOT) to improve the ability to purify emissions, and thus it is able to effectively purify emissions generated immediately after start-up.

A conventional GDI engine is designed to have a fuel injector mounted at a position adjacent to an intake valve and an intake port. In this design, we have discovered that as the injected fuel collides with the top surface of a piston and/or the surface of the intake valve, particulate matter (PM) and particulate number (PN) may be excessively produced, and also as the injected fuel collides with the inner wall surface of a cylinder, there is a high probability that engine oil dilution occurs.

In addition, we have found that the conventional GDI engine has a shorter mixing time of fuel and air than that of the PFI engine, so the fuel and the air may not be uniformly mixed. This may cause incomplete combustion in a portion in which the air-fuel mixture is densely distributed, resulting in producing excessive PM and PN.

Furthermore, in the conventional GDI engine, the injected fuel may interfere with the flow of the intake air depending on the direction of the injected fuel, which may reduce tumble strength.

The above information described in this background section is provided to assist in understanding the background of the inventive concept, and may include any technical concept which is not considered as the prior art that is already known to those skilled in the art.

### SUMMARY

The present disclosure has been made to solve the above-mentioned problems occurring in the prior art while advantages achieved by the prior art are maintained intact.

An aspect of the present disclosure provides a gasoline direct injection (GDI) engine which is designed to inject fuel so as not to interfere with an intake valve and/or the flow of intake air, thereby reducing particulate matter (PM) and particulate number (PN) and improving combustion performance.

According to an aspect of the present disclosure, a GDI engine may include: a cylinder block having at least one cylinder; a cylinder head including at least one intake port, at least one intake valve configured to open and close the at least one intake port, at least one exhaust port, and at least one exhaust valve configured to open and close the at least one exhaust port; a piston configured to reciprocate in the at least one cylinder; a combustion chamber defined by the cylinder head, the piston, and an inner wall surface of the at least one cylinder; and a fuel injector configured to inject a fuel into the combustion chamber. In particular, the combustion chamber may be divided into an intake side where the at least one intake port and the at least one intake valve are located, and an exhaust side where the at least one exhaust port and the at least one exhaust valve are located, and a nozzle of the fuel injector may be mounted in the cylinder head toward the exhaust side.

The cylinder head may have a mounting hole in which the nozzle of the fuel injector is mounted, and the mounting hole may be inclined at a predetermined angle with respect to a top surface of the piston.

The nozzle may inject the fuel into the combustion chamber at an injection angle corresponding to the predetermined angle of the mounting hole.

The cylinder head may have a first intake port which is opened and closed by a first intake valve, a second intake port which is opened and closed by a second intake valve, a first exhaust port which is opened and closed by a first exhaust valve, and a second exhaust port which is opened and closed by a second exhaust valve, and the mounting hole may be disposed between the first exhaust port and the second exhaust port.

The piston may have a cavity formed in a top surface of the piston, and the cavity may be adjacent to the exhaust side of the combustion chamber.

A central axis of the cavity may be offset from a central axis of the cylinder toward the exhaust side of the combustion chamber.

The cavity may include a plurality of grooves formed around in the periphery of the top surface of the piston, and the plurality of grooves may include a first intake side groove adapted to face or receive the first intake port, a second intake side groove adapted to face or receive the second intake port, a first exhaust side groove adapted to face or receive the first exhaust port, and a second exhaust side groove adapted to face or receive the second exhaust port.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a cross-sectional view of a gasoline direct injection (GDI) engine according to an exemplary form of the present disclosure;

FIG. 2 illustrates a plan view of a cylinder head in a GDI engine according to an exemplary form of the present disclosure;

FIG. 3 illustrates a perspective view of a relationship between a fuel injector and a piston in a GDI engine according to an exemplary form of the present disclosure;

FIG. 4 illustrates a relationship between air intake flow and fuel injection flow in a combustion chamber of a GDI engine according to an exemplary form of the present disclosure;

FIG. 5 illustrates a graph of tumble ratios in accordance with crank angles;

FIG. 6 illustrates a graph of turbulence kinetic energy in accordance with crank angles;

FIG. 7 illustrates a graph of piston wall film mass in accordance with crank angles;

FIG. 8 illustrates a graph of non-homogeneity of an air-fuel mixture in accordance with crank angles;

FIG. 9 illustrates a graph of characteristics of an air-fuel mixture in accordance with engine rpm; and

FIG. 10 illustrates a graph of wall film mass ratio in accordance with engine rpm.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, a detailed description of well-known techniques associated with the present disclosure will be ruled out in order not to unnecessarily obscure the gist of the present disclosure.

Terms such as first, second, A, B, (a), and (b) may be used to describe the elements in exemplary forms of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

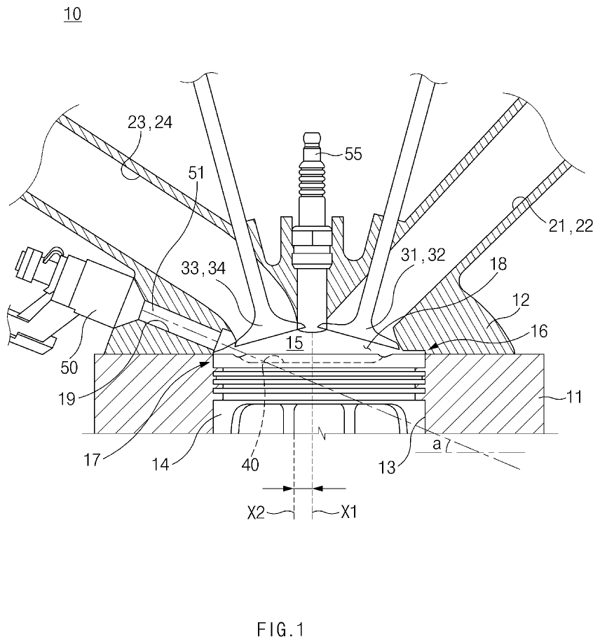

Referring to FIG. 1, a gasoline direct injection (GDI) engine 10 may include a cylinder block 11 and a cylinder head 12 connected to the cylinder block 11.

The cylinder block 11 may have a plurality of cylinders, and one cylinder 13 is illustrated in the drawing(s) for convenience of explanation. A piston 14 may be disposed to reciprocate in the cylinder 13.

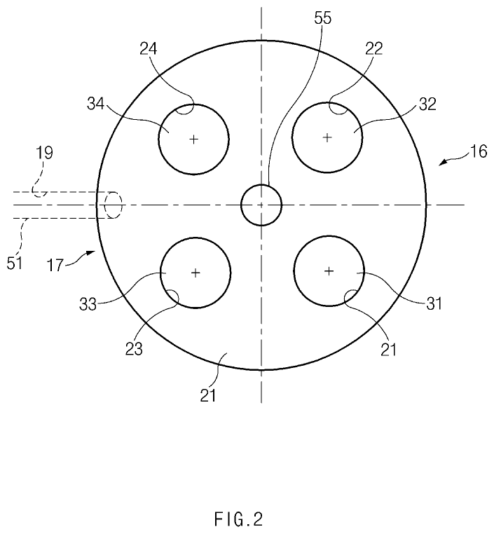

Referring to FIG. 2, the cylinder head 12 may have a first intake port 21, a second intake port 22, a first exhaust port 23, and a second exhaust port 24. The first intake port 21 may be opened and closed by a first intake valve 31, and the second intake port 22 may be opened and closed by a second intake valve 32. The first exhaust port 23 may be opened and closed by a first exhaust valve 33, and the second exhaust port 24 may be opened and closed by a second exhaust valve 34.

Referring to FIG. 1, a combustion chamber 15 may be defined by a recess 18 of the cylinder head 12, a top surface of the piston 14, and the cylinder 13. An upper space of the combustion chamber 15 may be divided into an intake side 16 where the intake ports 21 and 22 and the intake valves 31 and 32 are located, and an exhaust side 17 where the exhaust ports 23 and 24 and the exhaust valves 33 and 34 are located.

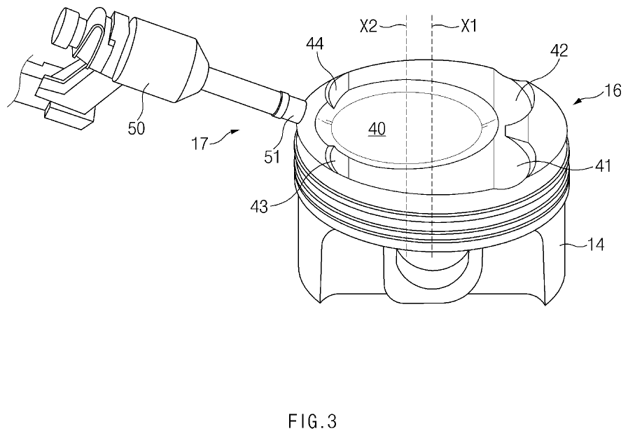

Referring to FIGS. 1 and 3, the piston 14 may have a cavity 40 formed in the top surface thereof, the cavity 40 may open toward the recess 18 of the cylinder head 12, the cavity 40 may constitute a portion of the combustion chamber 15. The cavity 40 may be disposed adjacent to the exhaust side 17 of the combustion chamber 15. For example, a central axis X2 of the cavity 40 may be offset from a central axis X1 of the cylinder 13 toward the exhaust side 17 of the combustion chamber 15 (especially, toward the first and second exhaust ports 23 and 24).

Referring to FIG. 3, the piston 14 may include a plurality of grooves 41, 42, 43, and 44 formed around in the periphery of the top surface of the piston 14. The plurality of grooves 41, 42, 43, and 44 is disposed around the cavity 14. The plurality of grooves 41, 42, 43, and 44 may include a first intake side groove 41 adapted to face or receive the first intake port 21, a second intake side groove 42 adapted to face or receive the second intake port 22, a first exhaust side groove 43 adapted to face or receive the first exhaust port 23, and a second exhaust side groove 44 adapted to face or receive the second exhaust port 24. When the first intake valve 31 fully opens the first intake port 21, the first intake valve 31 may be close to or in contact with the first intake side groove 41. When the second intake valve 32 fully opens the second intake port 22, the second intake valve 32 may be close to or in contact with the second intake side groove 42. When the first exhaust valve 33 fully opens the first exhaust port 23, the first exhaust valve 33 may be close to or in contact with the first exhaust side groove 43. When the second exhaust valve 34 fully opens the second exhaust port 24, the second exhaust valve 34 may be close to or in contact with the second exhaust side groove 44.

The cylinder head 12 may have a spark plug 55 and a fuel injector 50. The spark plug 55 may be disposed at the center of the combustion chamber 15, and the fuel injector 50 may be disposed adjacent to the exhaust side of the combustion chamber 15. The cylinder head 12 may have a mounting hole 19 inclined at a predetermined angle “a” with respect to the top surface of the piston 14 and/or the bottom surface of the cavity 40, as illustrated in FIG. 1. As the fuel injector 50 is mounted in the mounting hole 19 of the cylinder head 12, the fuel injector 50 may inject fuel into the combustion chamber 15.

The fuel injector 50 may have a nozzle 51 injecting the fuel, and the fuel injector 50 may inject the fuel into the combustion chamber 15 at a predetermined injection angle a corresponding to the inclined angle of the mounting hole 19.

Referring to FIG. 2, the mounting hole 19 may be located on the exhaust side of the combustion chamber 15, and the mounting hole 19 may be disposed between the first exhaust port 23 and the second exhaust port 24. Thus, the fuel injector 50 may be adjacent to the first exhaust port 23 and the second exhaust port 24.

According to an exemplary form of the present disclosure, the fuel injection angle a of the fuel injector 50 may be less than a fuel injection angle of a fuel injector mounted on the intake side of a conventional GDI engine. In particular, the fuel injection angle a may be determined to be sufficiently small so that the injected fuel may not directly collide with the intake valves 31 and 32 when the intake valves 31 and 32 open the intake ports 21 and 22.

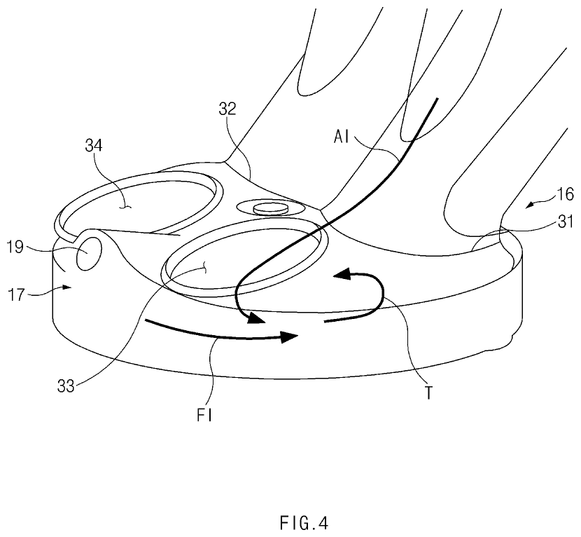

According to an exemplary form of the present disclosure, as the fuel injector 50 is located on the exhaust side of the combustion chamber 15, the fuel injector 50 may inject the fuel into the combustion chamber 15 when the air is introduced into the combustion chamber 15 through the intake ports 21 and 22 at the beginning of the intake stroke, and fuel injection flow FI and air intake flow AI may oppose each other as illustrated in FIG. 4. Thus, a probability that the injected fuel directly collides with the intake valves 31 and 32 may be avoided or minimized. As the air intake flow AI interferes with the straightness of the fuel injection flow FI, the injected fuel may not reach the top surface of the piston 14, and the formation of a wall film on the top surface of the piston 14 may be reduced or minimized. By minimizing the probability that the fuel directly collides with the intake valves 31 and 32 and the top surface of the piston 14, particulate matter (PM) and particulate number (PN) may be significantly reduced.

In addition, as the air intake flow AI and the fuel injection flow FI oppose each other during the early part of the intake stroke, the rotational flow of the air-fuel mixture may be strongly induced during the whole of the intake stroke, thereby strengthening tumble flow T.

Furthermore, as the air intake flow AI collides with the injection flow FI of the fuel injected in the opposing direction during the early part of the intake stroke, atomization of the air-fuel mixture may be increased, thereby contributing to the creation of a homogeneous mixture.

In addition, even though the fuel injector 50 injects the fuel on the exhaust side of the combustion chamber 15 during the intake stroke, there is little probability that the fuel directly collides with the exhaust valves 33 and 34 in a state in which the exhaust valves 33 and 34 close the exhaust ports 23 and 24.

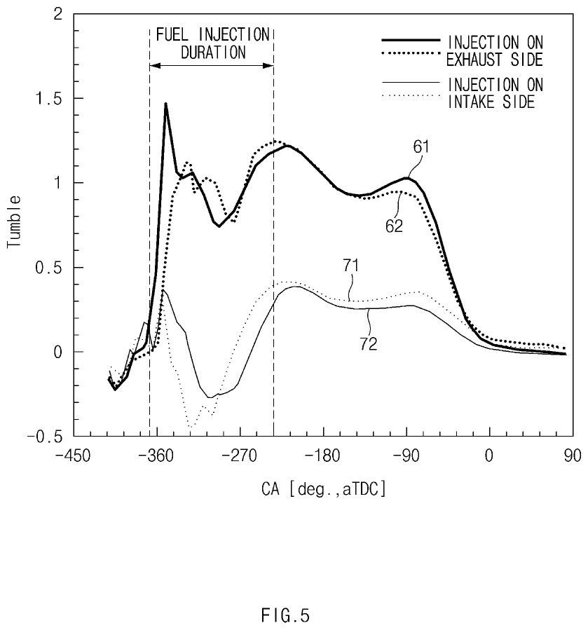

FIG. 5 illustrates a graph of tumble ratio in accordance with crank angle (CA). Reference numerals 61 and 62 denote curves representing tumble ratio variations with respect to crank angle in a GDI engine according to an exemplary form of the present disclosure, and the tumble ratio variations denoted by reference numerals 61 and 62 are distinguished by different revolutions per minute (rpm). Reference numerals 71 and 72 denote curves representing tumble ratio variations with respect to crank angle in a GDI engine according to the related art, and the tumble ratio variations denoted by reference numerals 71 and 72 are distinguished by different rpm. As illustrated in FIG. 5, it can be seen that the tumble ratio is significantly increased in the exemplary form of the present disclosure, compared to the related art.

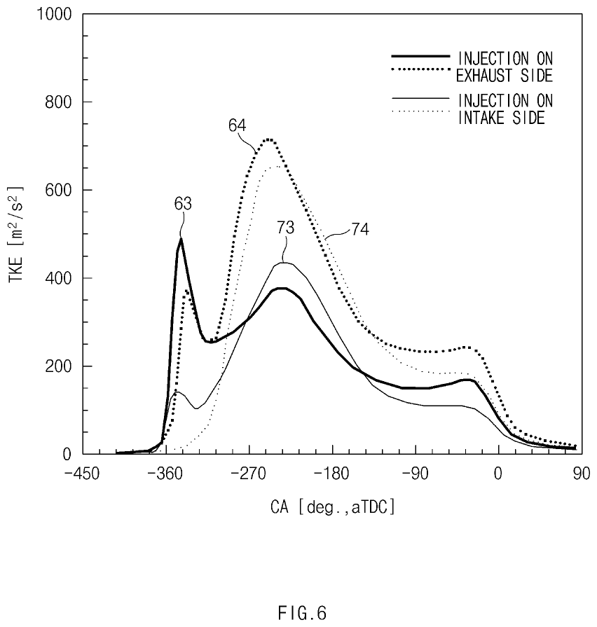

FIG. 6 illustrates a graph of turbulence kinetic energy (TKE) in accordance with crank angle (CA). Reference numerals 63 and 64 denote curves representing TKE variations with respect to crank angle in a GDI engine according to an exemplary form of the present disclosure, and the TKE variations denoted by reference numerals 63 and 64 are distinguished by different rpm. Reference numerals 73 and 74 denote curves representing TKE variations with respect to crank angle in a GDI engine according to the related art, and the TKE variations denoted by reference numerals 73 and 74 are distinguished by different rpm. As illustrated in FIG. 6, it can be seen that TKE is significantly increased in the exemplary form of the present disclosure, compared to the related art.

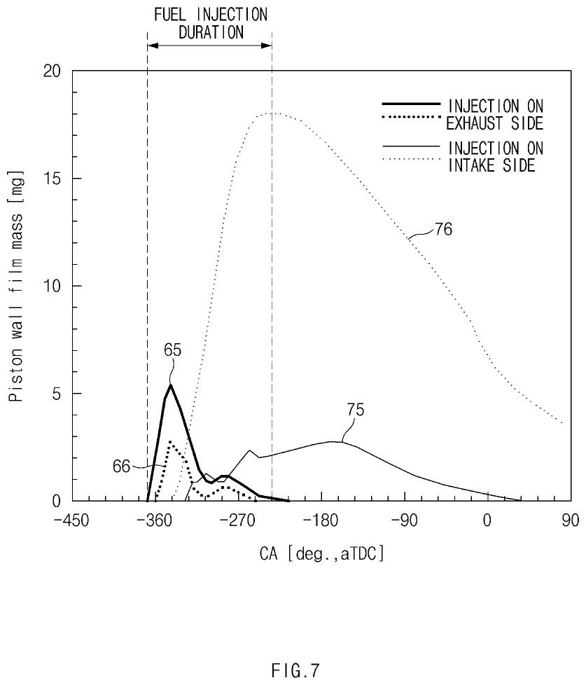

FIG. 7 illustrates a graph of piston wall film mass in accordance with crank angle (CA). Reference numerals 65 and 66 denote curves representing wall film mass formed on the surface of a piston with respect to crank angle in a GDI engine according to an exemplary form of the present disclosure, and the piston wall film mass variations denoted by reference numerals 65 and 66 are distinguished by different rpm. Reference numerals 75 and 76 denote curves representing wall film mass formed on the surface of a piston with respect to crank angle in a GDI engine according to the related art, and the piston wall film mass variations denoted by reference numerals 75 and 76 are distinguished by different rpm. As illustrated in FIG. 7, it can be seen that the piston wall film mass is significantly reduced in the exemplary form of the present disclosure, compared to the related art.

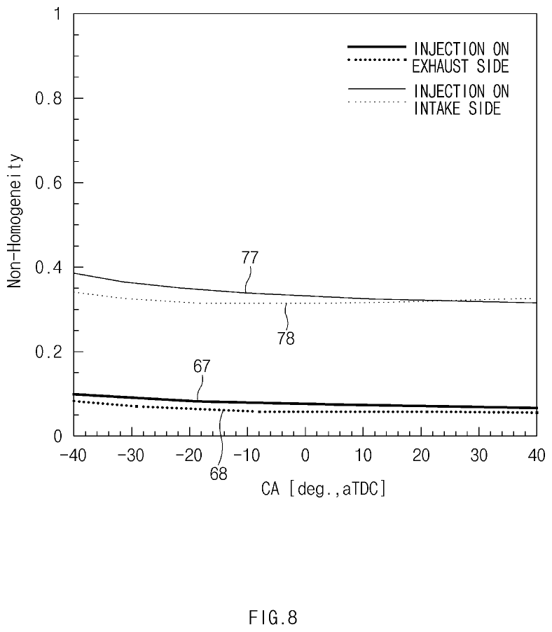

FIG. 8 illustrates a graph of non-homogeneity of an air-fuel mixture in accordance with crank angle (CA). Reference numerals 67 and 68 denote curves representing non-homogeneity of the air-fuel mixture with respect to crank angle in a GDI engine according to an exemplary form of the present disclosure, and the non-homogeneity variations denoted by reference numerals 67 and 68 are distinguished by different rpm. Reference numerals 77 and 78 denote curves representing non-homogeneity of the air-fuel mixture with respect to crank angle in a GDI engine according to the related art, and the non-homogeneity variations denoted by reference numerals 77 and 78 are distinguished by different rpm. As illustrated in FIG. 8, it can be seen that the non-homogeneity of the air-fuel mixture is significantly reduced in the exemplary form of the present disclosure, compared to the related art (that is, homogeneity is significantly improved). In FIG. 8, as non-homogeneity is lowered, the air and the fuel are homogeneously mixed.

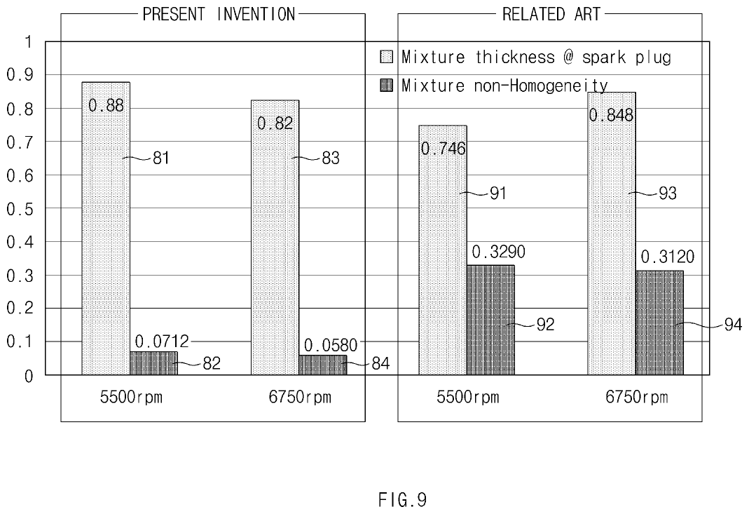

FIG. 9 illustrates a graph of characteristics of an air-fuel mixture in accordance with engine rpm. Reference numeral 81 denotes thickness of the air-fuel mixture which is formed when ignited by a spark plug in a GDI engine according to an exemplary form of the present disclosure in a state in which the engine rpm is 5500 rpm, and reference numeral 82 denotes non-homogeneity of the air-fuel mixture in the GDI engine in the state in which the engine rpm is 5500 rpm. Reference numeral 83 denotes thickness of the air-fuel mixture which is formed when ignited by the spark plug in the GDI engine in a state in which the engine rpm is 6750 rpm, and reference numeral 84 denotes non-homogeneity of the air-fuel mixture in the GDI engine in the state in which the engine rpm is 6750 rpm. Reference numeral 91 denotes thickness of the air-fuel mixture which is formed when ignited by a spark plug in a GDI engine according to the related art in a state in which the engine rpm is 5500 rpm, and reference numeral 92 denotes non-homogeneity of the air-fuel mixture in the GDI engine according to the related art in the state in which the engine rpm is 5500 rpm. Reference numeral 93 denotes thickness of the air-fuel mixture which is formed when ignited by the spark plug in the GDI engine according to the related art in a state in which the engine rpm is 6750 rpm, and reference numeral 94 denotes non-homogeneity of the air-fuel mixture in the GDI engine according to the related art in the state in which the engine rpm is 6750 rpm. As illustrated in FIG. 9, it can be seen that the air-fuel mixture thickness in the GDI engine according to the exemplary form of the present disclosure is nearly equal to or higher than that in the GDI engine according to the related art, and the homogeneity of the air-fuel mixture in the GDI engine according to the exemplary form of the present disclosure is better than that in the GDI engine according to the related art. In FIG. 9, the non-homogeneity of the air-fuel mixture indicates the degree of mixture of air and fuel, and as its value is lowered, the air and the fuel are homogeneously mixed.

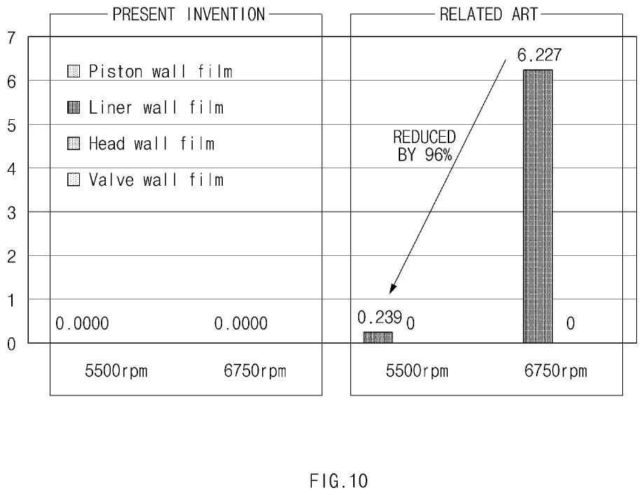

FIG. 10 illustrates a graph of wall film mass ratio in accordance with engine rpm. The formation of wall film may hardly occur, irrespective of engine rpm, in a GDI engine according to an exemplary form of the present disclosure. In a GDI engine according to the related art, the wall film mass ratio (wall film formed on the top surface of the piston) is 0.239 in a state in which the engine rpm is 5500 rpm, and is 6.227 in a state in which the engine rpm is 6750 rpm. As illustrated in FIG. 10, it can be seen that the formation of wall film can hardly occur on the surfaces of the piston, liner, head, intake valve, exhaust valve, and the like in the exemplary form of the present disclosure.

As set forth above, the GDI engine, according to exemplary forms of the present disclosure, is designed to have the fuel injector disposed adjacent to the exhaust side of the combustion chamber and injecting the fuel so as not to interfere with the intake valve and/or the flow of intake air, thereby reducing particulate matter (PM) and particulate number (PN) and improving combustion performance.

In addition, according to exemplary forms of the present disclosure, as the fuel injector on the exhaust side injects the fuel into the combustion chamber, the air intake flow and the fuel injection flow may oppose each other during the early part of the intake stroke, so the rotational flow of the air-fuel mixture may be strongly induced during the whole of the intake stroke, thereby strengthening tumble flow T.

Furthermore, as the air intake flow from the intake port collides with the injection flow of the fuel injected in the opposing direction during the early part of the intake stroke, atomization of the air-fuel mixture may be increased, thereby contributing to the creation of a homogeneous mixture. In addition, even though the fuel injector injects the fuel from the exhaust side of the combustion chamber during the intake stroke, there is little probability that the fuel directly collides with the exhaust valve in a state in which the exhaust valve closes the exhaust port.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. A gasoline direct injection (GDI) engine, comprising:
a cylinder block including at least one cylinder;
a cylinder head including at least one intake port, at least one intake valve configured to open and close the at least one intake port, at least one exhaust port, and at least one exhaust valve configured to open and close the at least one exhaust port;
a piston configured to reciprocate in the at least one cylinder;
a combustion chamber defined by the cylinder head, the piston, and an inner wall surface of the at least one cylinder; and
a fuel injector configured to inject a fuel into the combustion chamber,
wherein the combustion chamber is divided into an intake side where the at least one intake port and the at least one intake valve are located, and an exhaust side where the at least one exhaust port and the at least one exhaust valve are located, and
wherein a nozzle of the fuel injector is mounted in the cylinder head toward the exhaust side.

2. The GDI engine according to claim 1, wherein the cylinder head has a mounting hole in which the nozzle of the fuel injector is mounted, and
the mounting hole is inclined at a predetermined angle with respect to a top surface of the piston.

3. The GDI engine according to claim 2, wherein the nozzle injects the fuel into the combustion chamber at an injection angle corresponding to the predetermined angle of the mounting hole.

4. The GDI engine according to claim 2, wherein the at least one intake port includes a first intake port and a second intake port, and the at least one intake valve includes a first intake valve and a second intake valve,
wherein the first intake valve is configured to open and close the first intake port, and the second intake valve is configured to open and close the second intake port,
wherein the at least one exhaust port includes a first exhaust port and a second exhaust port, and the at least one exhaust valve includes a first exhaust valve and a second exhaust valve,
wherein the first exhaust valve is configured to open and close the first exhaust port, and the second exhaust valve is configured to open and close the second exhaust port, and
wherein the mounting hole is disposed between the first exhaust port and the second exhaust port.

5. The GDI engine according to claim 4, wherein a cavity is formed in a top surface of the piston, and
the cavity is adjacent to the exhaust side of the combustion chamber.

6. The GDI engine according to claim 5, wherein a central axis of the cavity is offset from a central axis of the at least one cylinder toward the exhaust side of the combustion chamber.

7. The GDI engine according to claim 5, wherein the cavity includes a plurality of grooves formed around in a periphery of the top surface of the piston, and
the plurality of grooves include a first intake side groove adapted to receive the first intake port, a second intake side groove adapted to receive the second intake port, a first exhaust side groove adapted to receive the first exhaust port, and a second exhaust side groove adapted to receive the second exhaust port.
